(19) United States
(12) Patent Application Publication
(10) Pub. No.: US 2010/0270506 A1
(43) Pub. Date: Oct. 28, 2010

(54) TWO STAGE PROCESS FOR CONVERTING BIOMASS TO SYNGAS

(76) Inventors: DUANE A. GOETSCH, Andover, MN (US); Jacqueline Hitchingham, Anoka, MN (US); Lloyd R. White, Minneapolis, MN (US)

Correspondence Address: HENRY E. NAYLOR & ASSOCIATES, P.O. BOX 86060, BATON ROUGE, LA, 70879-6060, US

(21) Appl. No.: 12/767,501

(22) Filed: Apr. 26, 2010

Related U.S. Application Data
(60) Provisional application No. 61/214,482, filed on Apr. 24, 2009.
(60) Provisional application No. 61/270,645, filed on Jul. 10, 2009.
(60) Provisional application No. 61/295,355, filed on Jan. 15, 2010.

(51) Int. Cl. C01B 3/02; B01J 8/18

(52) U.S. Cl. 252/373; 422/141

(57) ABSTRACT

A two stage conversion process for converting biomass to a syngas, wherein the first stage is a gasification stage and the second stage is a combustion stage.

### CROSS REFERENCE TO RELATED APPLICATIONS

This application claims benefit of Provisional Applications 61/214,482 filed Apr. 24, 2009; 61/270,645 filed Jul. 10, 2009; and 61/295,355 filed Jan. 15, 2010.

### FIELD OF THE INVENTION

The present invention relates to a two stage conversion process for converting biomass to a syngas. The first stage is a gasification stage and the second stage is a combustion stage.

### BACKGROUND OF THE INVENTION

Gasification is a process that converts carbonaceous materials, such as coal, petroleum, or biomass into predominantly carbon monoxide and hydrogen (syngas) by reacting the carbonaceous material at high temperatures with a controlled amount of oxygen and/or steam. Syngas may be burned directly in internal combustion engines, used to produce methanol and hydrogen, or converted via the Fischer-Tropsch process into synthetic fuels.

Gasification of fossil fuels is currently widely used to generate electricity. However, almost any type of organic material can be used as the raw material for gasification, including biomass and plastic waste. Thus, gasification has the potential to be an important technology for renewable energy and is typically carbon neutral. U.S. Pat. No. 6,767,375 teaches a biomass reactor for producing syngas. The biomass reactor, which is basically a gasifier, includes a helical coil disposed concentrically in the reactor vessel with a burner positioned at the bottom of the vessel and a generally cylindrical heat shield, with the bottom end being closed at the top of the vessel.

U.S. Pat. No. 7,228,806 teaches a biomass gasification system for extracting heat energy from biomass. The biomass gasification system includes a primary combustion chamber, a rotating grate within the primary combustion chamber for supporting the biomass during gasification, a feeder unit in communication with the primary combustion chamber, a secondary combustion chamber, an oxygen mixer, and a heat exchanger and an exhaust stack. Also U.S. Pat. No. 6,972,114 teaches a biomass gasifier apparatus and method to produce low BTU gas from biomass while removing char and ash.

Also, United States Patent Application No. 2008/0216405 teaches a carbonization and gasification biomass process wherein the biomass is first carbonized, and then the resulting char and pyolysis gas are fed respectively to a high temperature gasifying step and to a gas reformer, to maintain the temperature required to avoid tar formation in the gas reformer stage.

Biomass gasification carries significant energy debits compared to coal and petroleum based feed materials due to the relatively low carbon content of materials, such as plant biomass. Gasification reactions are complicated by the presence of relatively high oxygen content, resulting in a significant amount of CO₂ within the product synthesis gas. Most biomass gasifiers currently in use, or under commercial development, operate at relatively low pressures (<100 psig) in order to achieve the desired thermal flux necessary to achieve high gasification yields while minimizing the formation of undesired tar and soot. Typical conventional biomass gasifiers operate with significant temperature gradients (>200° F.) because of the need to supply heat for the endothermic reaction that produces syngas.

While there is much activity in the field of biomass to fuel technology using gasification, there is still a need in the art for improved and more efficient processes for converting biomass to syngas using gasification for at least one stage.

### SUMMARY OF THE INVENTION

In accordance with the present invention there is provided a two-stage process unit for converting a biomass feedstock to a syngas gas, which process comprises:

a) introducing an effective amount of steam into a gasifier stage containing a bed of fluidized solids;

b) introducing a fluidizing gas through a first plurality of nozzles located at the bottom of said first stage containing said bed of solids, thereby resulting in and maintaining the fluidized bed of solids;

c) operating said first stage at a temperature of about 1000° F. to about 1600° F.;

d) introducing a biomass feedstock having an organic fraction and an inorganic fraction, in particulate form, into said first stage containing a fluidized bed of solids wherein the residence time of said biomass in said first gasification reactor is an effective residence time that will result in conversion of at least about 90% of the organic fraction to gaseous products, thereby resulting in a syngas product stream and a carbon-rich particulate product;

e) pulsing oxygen through a plurality of nozzles into said first stage, wherein said pulsing is preformed to maintain the temperature of said first stage in the range from about 1000° F. but not greater than about 1600° F., and to keep the partial oxidation zone of said nozzles below the fusion temperature of the inorganic fraction of said biomass, wherein said plurality of nozzles are divided into one or more sets with each set of nozzles pulsing oxygen at the same or at a different frequency of time;

f) passing at least a fraction of said syngas phase product stream to a solids/gas separation zone wherein substantially all of any solids carried in said syngas product stream are removed, thereby resulting in a substantially solids-free syngas product stream;

g) passing said substantially solids-free syngas product stream to downstream processing;

h) transporting said carbon-rich particulate product from said gasification stage to a combustor stage;

i) introducing, through a second plurality of nozzles, an effective amount of a fluidizing gas into said second stage, thereby resulting in a second fluidized bed of biomass particulates and fluidizing solids;

j) operating said second stage in the temperature at least about 50° F. greater than that of said first stage, but not in excess of about 2000° F. and at a residence time from about 1 to 3 times that of said first gasification reactor;

k) returning at least a portion of the solids of second stage to said first stage; and

l) removing any excess solids from the process unit to maintain a predetermined balance of solids.

### BRIEF DESCRIPTION OF THE FIGURE

FIG. 1 hereof is a representation of a preferred embodiment of a two stage process unit for converting biomass to a predominantly gaseous product wherein the first stage is a gasification stage and the second stage is a combustion stage.

FIG. 2 hereof is representation of a typical section of a gasifier showing a nozzle arrangement wherein fluidizing gas an oxygen for pulsing will be introduced.

FIG. 3 hereof is a simplified drawing showing what applicants believe to be a preferred sequencing of pulsed oxygen into the gasification reactor of the present invention.

FIG. 4 hereof is a representation of a preferred time sequencing of oxygen injection into the gasification reactor of the present invention.

### DETAILED DESCRIPTION OF THE INVENTION

“Lignocellulosic feedstock,” is any type of plant biomass such as, but not limited to, non-woody plant biomass, cultivated crops, such as, but not limited to, grasses, for example, but not limited to, C4 grasses, such as switchgrass, cord grass, rye grass, miscanthus, reed canary grass, or a combination thereof, or sugar processing residues such as bagasse, or beet pulp, agricultural residues, for example, soybean stover, corn stover, rice straw, rice hulls, barley straw, corn cobs, wheat straw, canola straw, rice straw, oat straw, oat hulls, corn fiber, recycled wood pulp fiber, sawdust, hardwood, for example aspen wood and sawdust, softwood, or a combination thereof. Further, the lignocellulosic feedstock may include cellulosic waste material such as, but not limited to, newsprint, cardboard, sawdust, and the like. For urban areas, the best potential plant biomass feedstock includes yard waste (e.g., grass clippings, leaves, tree clippings, and brush) and vegetable processing waste.

Lignocellulosic feedstock may include one species of fiber or alternatively, lignocellulosic feedstock may include a mixture of fibers that originate from different lignocellulosic feedstocks. Furthermore, the lignocellulosic feedstock may comprise fresh lignocellulosic feedstock, partially dried lignocellulosic feedstock, fully dried lignocellulosic feedstock or a combination thereof. In general, the term “biomass” as used herein includes all of the terms, plant biomass, liqnocellulosic, cellulosic, and hemicellulosic. It is preferred that the biomass used in the practice of the present invention comprised at least about 30 wt. % cellulose/hemicelluloses, based on the total weight of the biomass.

The biomass is preferably dried before feeding to the two stage process unit of the present invention. It is preferred that the biomass, after drying, contain no more than about 20 wt. %, preferably not more that about 15 wt. %, and more preferably no more than about 10 wt. % water, based on the total weight of the biomass after drying. The biomass is subjected to a size reduction step to reduce it a size suitable for gasification in the first stage or for feed to a torrefaction step. It is preferred that the size reduction step produce a biomass having a particle size of about 1 micron to about 3 inches, preferably from about 150 microns to about 1.5 inches, and more preferably from about 300 microns to 1.5 inches. The fibrous structure of the biomass makes it very difficult and costly to reduce its particle size. Non-limiting examples of mechanical size reduction equipment include rotary breakers, roll crushers, jet mills, cryogenic mills, hammermills, impactors, tumbling mills, roller mills, shear grinders, and knife mills. Hammermills are preferred for the practice of the present invention.

It is more preferred that the biomass be reduced in size by torrefying it at moderate temperatures in an oxygen-free atmosphere. Torrefaction increases the energy density of cellulosic materials by decomposing the fraction of hemicelluloses that is reactive. The energy content per unit mass of torrefied product is increased. Much of the energy lost during torrefaction is in an off-gas (tor-gas) that contains combustibles, which can be burned to provide some of the heat required by the torrefaction process.

Torrefaction of biomass of the present invention is conducted at temperatures from about 390° F. to about 665° F., preferably from about 435° F. to about 610° F., more preferably from about 480° F. to about 575° F. During torrefaction, the biomass properties are changed, which results in better fuel quality for combustion and gasification applications. Typically, torrefaction is followed by pelletizing to yield a product that is suitable as a fuel substitute for coal. In this case, the torrefied biomass of the present invention is not pelletized, but is instead reduced to a particle size that will be suitable for use in a fluid-bed gasifier. This particle size will typically be in the range of about 1 micron to 300 microns, preferably from about 150 microns to about 300 microns. It only torrefaction is used to reduce the size and to pretreat the biomass feedstock of the present invention, then the particle size range will be from about 1 micron to about 300 microns. If torrefaction is not used then the particle size range can be as high as 3 inches. In the torrefaction of the present invention, the hemicelluloses and, depending on severity, some of the cellulose in the biomass undergo hydrolysis and dehydration reactions. The process primarily removes CH₃O—, HCOO—, CH₃COO— functional groups from the hemicellulose. Hydrolysis reactions also cleave the C—O—C linkages in the polymeric chains that comprise the major constituents in the biomass. The acidic components in the tor-gas and the ash components in the biomass have the potential to catalyze these reactions. The torrefaction process produces a solid product having higher energy density than the feedstock and a tor-gas. The solid product can result in char during gasification and can contribute to heat balance needed for the gasifier. Particle size reduction occurs during this process as a result of chemical action rather than mechanical actions as in grinding. Overall, the process uses less electrical power to achieve a desired degree of size reduction.

Further, torrefaction converts a wide array of cellulosic biomass into particulate matter having similar properties. If desired, the severity of the torrefaction process can be altered to produce a torrefied product having the same energy content as that produced from a completely different biomass feedstock. This has implicit advantages in the design of the gasifier feed system and greatly simplifies gasifier operation with respect to controlling the H₂:CO ratio in the syngas, In addition, by selectively removing the carboxylates in the torrefaction unit, it is believed that less methane will be produced as a result of decarboxylation and fewer tars will be formed during gasification by reactions between aldehydes produced from these carboxylic acids and phenols derived from lignin. Also, torrefaction results in a reduced amount of phenolic intermediates resulting in less tar formation.

Torrefied biomass retains a high percentage of the energy content of the biomass feedstock (ca. ˜90%). Gaseous products produced by torrefaction are comprised of condensable and non-condensable gases. The condensable gases are primarily water, acetic acid, and oxygenates such as furfural, formic acid, methanol, and lactic acid. Typically, the biomass feedstock is dried prior to torrefaction to facilitate use of the condensable oxygenates as a heating fuel (typically having a heating content greater than 65 BTU/SCF). The non-condensable gases are comprised primarily of carbon dioxide and carbon monoxide, but may also contain small amounts of hydrogen and methane.

There is presently no commercial biomass high-pressure gasification processes. Conventional low-pressure gasifiers thus require a very expensive and most often (economically) prohibitive gas compression step. As a result, the high pressure gasifier system of the present invention substantially decreases the size of, and preferably eliminates, the compression step typically required for post-gasifier conversion processes.

The gasification process as applied to the conversion of carbonaceous materials involves many individual reactions associated with conversion of carbon, hydrogen, and oxygen into products involving steam, hydrogen, oxides of carbon, soot or tars and hydrocarbons. At elevated temperatures (>1000° F.) associated with gasification, the major products are typically steam and syngas comprised of hydrogen, CO₂, CO and methane. Chars and soot represent compounds rich in carbon and may contain small amounts (<5%) of hydrogen.

Substantially all of the reactions during gasification occur simultaneously within the gasification reactor (when oxygen is present). Since the gasification process is endothermic in nature, heat must be supplied in order to maintain the elevated temperatures. Gasifiers can be classified with respect to how they provide this heat. Indirect gasifiers utilize heat transfer tubes or other surfaces within the gasifier reactor. An external source of hot gas passes through the tubes to provide heat to the gasification reactor. The maximum operating temperature for these types of gasifiers is typically <1600° F. due to the material limitations associated with the heat transfer area. Expensive high temperature metal alloys or other heat transfer materials can be utilized; however, the mechanical complications associated with thermal stress prohibit operations in the desired range of 1800° F. High temperature gasifiers (>1800° F.), such as those utilized for coal, employ O₂ in the feed and provide the necessary thermal energy for driving the endothermic reactions through partial oxidation. This use of internally generated heat is referred to as a “direct” or O₂-blown gasifier which can achieve almost complete conversion of the feed carbon. Coal gasifiers (direct type) generally operate in what is referred as the slagging mode since the temperatures achieved within the partial oxidation zone are very high (>2000° F.) and the inorganic constituents (also referred to as ash) undergo “fusion” or are converted to liquids which collect at the bottom of the gasifier and are periodically or continuously drawn out of the system. However, when this technology is applied to biomass, issues arise due to the inorganic content within the feed matrix. Biomass typically contains higher concentrations of inorganic constituents which can vaporize at elevated temperatures and deposit on downstream equipment causing fouling of heat transfer surfaces and operational problems.

To date, all commercial gasifier systems that employ O₂ to supply thermal energy through partial oxidation generate localized hot spots at the injection point or zone. The reaction of oxygen in the gasification environment is very fast and for all practical purposes occurs within the jet volume associated with the O₂ injection nozzle. The O₂ jet forms essentially a volume around the nozzle which is referred to as the partial oxidation, or pox, zone. Within this volume, localized temperatures can approach the adiabatic flame temperature determined by the combustion of the available oxygen and the local fuel which is typically synthesis gas. It will be understood that the terms synthesis gas, syngas, and synthetic gas are used interchangeably herein. The endothermic reactions (gasification and pyrolysis) do not occur as fast as oxidation and consequently more chemical heat is generated than removed. One possible way to mitigate the high temperatures is to transfer cooler solids and gas through the partial oxidation (pox) region. A fluidized bed reactor using inert solids provides geometry to mitigate the higher temperatures. A solid with catalytic properties will provide additional heat mitigation through promotion of the steam reforming of gaseous hydrocarbons produced through pyrolysis. For example, adding an effective amount of potassium to the circulating solids will catalyze the gasification rate of gaseous intermediates produced from the biomass.

Another way to mitigate the high temperatures is to use pulsed oxygen injection so as to keep the maximum temperature within the oxygen injection region (referred to as the flame zone) below the fusion temperature of the biomass. This method for controlling this temperature involves the periodic injection of oxygen at a flow rate and frequency that prevents the attainment of temperatures approaching or exceeding the fusion temperature of the inorganic constituents within the biomass feed. Additionally, operating at temperatures in the range of about 1400° F. to about 1600° F. reduces the extent of volatility of these constituents, thereby minimizing fouling on downstream equipment.

Temperature control using pulsed oxygen is practiced in both stages when oxygen is used. However, the second stage (combustor) can also make use of air, which can be feed continuously. The biomass feed is preferably introduced through a riser exiting at or near the bottom of the first stage fluid bed in which both pyrolysis and gasification occur simultaneously. The lift gas employed by the riser is preferably comprised of a steam/carbon dioxide mixture. Variation of the lift gas composition influences the extent of pyrolysis and hydrolysis reactions that occur in the riser. Variation in the lift gas composition influences the fluidization properties of the particulate biomass, most importantly its tendency to agglomerate. The feed system is oriented to provide maximum contact of the biomass with the oxygen, steam and other fluidizing gases within the fluid bed. The use of both steam and oxygen minimizes the extent of pyrolysis; however, this reaction will still proceed to some extent resulting in the production of tars, soot and other carbon rich solids which inherently gasify at a much slower rate than the parent biomass feed. The heat required in the first stage is significant since most of the biomass gasification and all of the pyrolysis occurs in this stage (endothermic reactions). This first stage is operated at a lower temperature (1000° F.-1600° F.) than the second stage, which is operated at a temperature at least 50° F. greater, preferably at least about 100° F. greater than the first stage in order to reduce the potential for high temperatures within the pox zone. It is preferred that the second stage not be operated at temperatures greater than 2000° F., more preferably no greater than about 1900° F. The upper temperature of this second stage is the point where an undesirable amount of slag is formed.

The carbon-rich phase is comprised of char and other carbon rich intermediates arising from pyrolysis as well unreacted biomass. The gaseous phase contains H₂, CO, CO₂, H₂O and CH₄ as well as minor amounts of other hydrocarbons arising from the pyrolysis reaction. At least a portion, preferably substantially all, of the gaseous phase (syngas) from the first stage is removed as a final product, while the carbon-rich solid phase is sent to the second stage, which, as previously been mentioned, is operated at a higher temperature than the first stage in order to facilitate the combustion of the tars and other carbon rich solids.

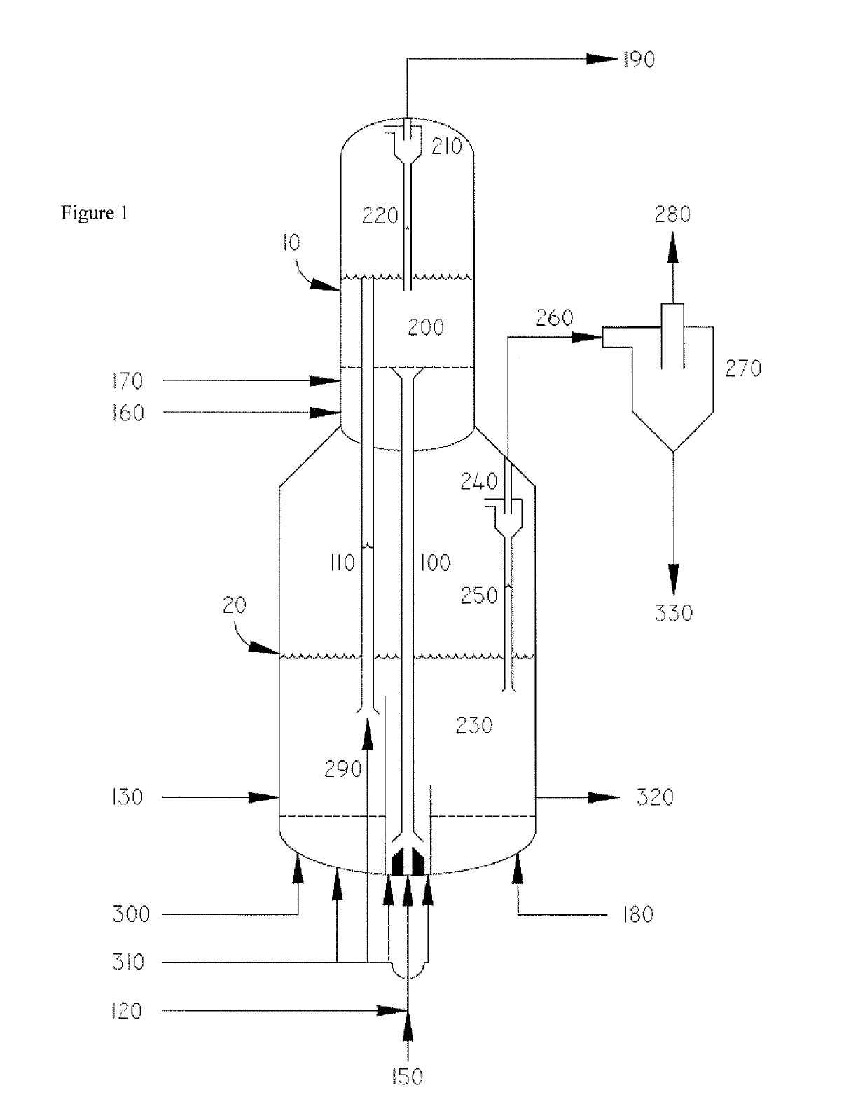

The instant invention will be better understood with reference to the figures hereof. FIG. 1 hereof presents the major components of a preferred two-stage biomass conversion system of the present invention. The conversion system is comprised of two fluid stages depicted as a first stage designated as reactor 10 and a second stage designated as reactor 20, which sits directly below first stage 10. This first stage is a gasification stage and the second stage is a combustion stage. The two reactors shown in this figure are fluidly connected via riser 100 and down-corner or standpipe 110. The feed will preferably be a biomass having a particle size as previously discussed.

The particulate biomass material is preferably fed to riser 100 via line 120, which conveys it to the first stage 10 via the lift gas provided from line 150. The feed system is preferably oriented to provide maximum contact of the biomass with oxygen, steam and other fluidizing gases within the fluid bed 200. It will be understood that not all of the biomass feed need be introduced via a riser but at least a fraction of it can be introduced into the gasification stage at any other suitable location in the fluidized bed. Any suitable fluidizing gas can be used in the practice of the present invention. For purposes of this invention, it will be understood that all fluidized beds have a dilute phase zone and a dense phase zone and each are typically expressed as solid volume in that particular zone. For example, the dilute phase zone typically has a solid volume of from about 0.01% to about 15%, preferably from about 0.02% to about 1%, and more preferably from about 0.03% to about 0.1%. The dilute phase zone typically has about 1% or less of the solid volume contained in the dense phase zone, preferably about 0.1% or less, and more preferably about 0.01% or less. In one embodiment of the present invention the dense phase zone has a solid volume content of from about 20% to about 40%, preferably from about 15% to about 35%.

In addition to the chosen biomass feed particulates, inert or catalytic fluidization solids can be introduced into the fluidized beds 200 and 230 in order to facilitate heat transfer, to promote gasification, or both. The preferred fluidization solids are alpha alumina, preferably spray dried alpha alumina. The alpha alumina can also be doped with a catalytic component, such as Ca or K. The size range for the fluidization solids will be those based on Group A an Group B of the Geldart Groupings. That is having a particle size range from about 20 microns to about 500 mircons with densities between about 1400 kg/m³. These fluidization solids can be introduced with the primary feed within vessel 10 via line 120 or they can be fed separately through a dedicated nozzle represented by inlet 130 to the second stage 20. They can also be fed at any other suitable location of the process unit by use of any suitable device that is used to incorporate a material into a pressurized vessel, which devices are well know in the art.

The fluidization gas for both gasification and combustion can be any suitable gas. Non-limiting examples of such gases include steam, carbon dioxide, nitrogen, natural gas, liquid hydrocarbons and syngas. Steam is a preferred fluidization gas as well as CO₂ generated from the biomass feedstock or a mixture of both. More preferred is steam. The fluidization gas is introduced into the first and second stages via a suitable nozzle system, such as via lines 160 and 180/310 respectively. Such nozzle systems are well known in the art. Oxygen, or an oxygen-containing gas, is also introduced at specified locations within the reactor configuration, such as at 170 and 180, in order to generate the thermal energy required to drive the endothermic reactions associated with gasification and reforming. It will be understood that air is preferably injected via line 180 instead of oxygen. The feed rates of the biomass, oxygen, steam as well as other gases will be established by the criteria for establishing an acceptable gas fluidization rate and providing the appropriate carbon, hydrogen and oxygen ratios for achieving the desired syngas composition.

Because of the high temperatures required for both stages, the system is preferably heated using direct methods, by addition of O₂ to the first stage and preferably air to the second stage. The maximum temperature within the oxygen injection region (which is also sometimes referred to as the flame or pox zone) must be below the fusion temperature of the biomass. The preferred method for controlling this temperature involves the periodic injection of oxygen at a flow rate and frequency that prevents the attainment of the fusion temperature of the inorganic constituents of the biomass feed. Additionally, operating at global temperatures in the preferred range of about 1400° F. to about 1600° F. reduces the extent of volatility of these constituents thereby minimizing fouling on downstream equipment.

Temperature control using pulsed oxygen, as previously mentioned, is practiced in the first stage and is optional in the second stage. The use of both steam and oxygen minimizes the extent of pyrolysis; however, this reaction will still proceed to some extent, resulting in the production of char, soot and other carbon-rich solids that will gasify at a slower rate than the parent biomass material. The heat required for the first stage is significant since most of the biomass gasification and substantially all of the pyrolysis occurs in this reactor (endothermic reactions). The first stage operates at a lower temperature than second stage. That is, the second stage will be operated at a temperature of at least 50° F., preferably at least about 100° F. greater than that of thefirst stage. The upper temperature limit of this second stage will be the fusion temperature of the inorganic material as evidenced by an undesirable amount of slag formation.

The products from the first stage includes a solid phase comprised primarily of char and other carbon-rich intermediates arising from pyrolysis, as well as unreacted biomass. A gaseous syngas phase also results, comprised primarily of H₂, CO, CO₂, H₂O and CH₄ as well as a small amount other hydrocarbons arising from the pyrolysis reaction. The gas from the first stage is removed and passed to downstream processing to make end products such as various chemicals and transportation fuels. The solid products are sent to the second stage, which is operated at a higher temperature in order to facilitate the combustion of the tars and other carbon-rich solids.

Upon entry into the first stage 10, the biomass feed immediately reacts with the stream containing the fluidization gas and undergoes both pyrolysis and gasification. The pyrolysis reactions lead to the formation of char and soot-like solids comprised predominately of carbon. The temperature within the first stage 10 should be as high as possible but below the slagging, or fusion, temperature of the inorganic components of the biomass. In order to maintain this temperature, oxygen or an oxygen-containing gas is introduced into first stage 10 as previously described. Conduit 160 represents the inlet for the fluidizing gas that is preferably steam or recycle gas. The location of the inlet conduits for the fluidizing gases will be located at or near the bottom of the fluidized bed 200. Normal commercial practice is employed in this design based on achieving sufficient gas velocities to suspend the biomass and other solids present within the reactor. The first stage can be operated to adjust the desired composition of the resulting syngas having a H₂ to CO ratio from about 0.8 to about 2.3.

As previously mentioned, the biomass within the first stage 10 will undergo both gasification and pyrolysis which will lead to the formation of synthesis gas as well as carbon-rich solids. Pyrolysis can also lead to tar-like solids if allowed to exit the reactor in an insufficient time frame that does not allow further gasification and pyrolysis to occur. The solids generated in the first stage 10 travel down down-corner 110 into the second stage 20. The fluidization characteristics of the solids generated in the first stage 10 and the amount of gas to be moved define the preferred geometry of the riser.

The gases produced in the first stage 10 exit the reactor through the cyclone 210. Solids transported with the gases into cyclone 210 are returned to the first stage 10 through solids return 220. Some gases will pass through inter-vessel down-corner 110, but this will not be a significant volume since the flow area of down-corner 110 is very small, typically less than about 5% of the total cross sectional area of the first stage 10. Also, this gas volume can be further minimized by direct steam injection into the down-corner via line 290. A plurality of exit cyclones 210 and down-corners 110 can be employed, especially when the desired throughput rate exceeds the practical limit of a single unit.

The total reactor volume available for gasification and pyrolysis preferably corresponds to an effective solids residence time. By “effective solids residence time” we mean that amount of time needed to convert at least about 90 wt. %, preferably at least about 95 wt. %, and more preferably at least about 98 wt % of the carbon of the biomass. This effective amount of time will typically be from about 5 to 90 seconds based on the biomass feed volume at a temperature in the range of about 1000° to about 1600° F. Longer residence times are preferred. Consequently, riser 100 is sized appropriately to assist in maintaining the desired temperature of the gasifier. Operations at higher temperatures of about 1650° to about 2000° F. in the second stage will allow shorter residence times while the converse is true at lower temperatures. The preferred operating temperature and residence time for the first stage 10 is based on maximizing the amount of conversion of the biomass to synthesis gas or conversely minimizing the amount of carbon-rich solids (non-syngas products) produced. The depth of the fluid bed 200 within the first stage 10 will be dependent upon the minimum depth required for stable fluidization and the required residence time as well as the gas velocity. Conventional fluid bed parameters can be used.

The second stage 20 comprises of a fluidized bed 230 that combusts the carbon-rich solids transferred from the first stage 10 via down-corner 110. The fluidization conditions for the second stage involve a much higher fraction of inert solids and the desired temperature range is higher in order to facilitate the combustion of the rich carbon containing solids generated through pyrolysis. The total amount of oxygen contained within the fluidizing gas is preferably sufficient to maintain the preferred temperature and to be introduced in the appropriate manner to avoid any excessive temperature zones which lead to liquid formation through slagging or fusion of the inorganic constituents within the solids. The depth and diameter of the fluid bed 230 in the second stage 20 is determined by several criteria involving the following:

a) Minimum fluidization velocity to achieve sufficient mixing while maintaining as high a temperature as possible without slagging or otherwise forming a liquid phase from the inorganic constituents.

b) Achieving sufficient residence time for gasifying a high fraction (>90%) of the carbon containing solids transferred into the second stage 20.

c) Introducing the oxygen over a sufficient area and volume to minimize the high temperature region associated with partial oxidation and combustion,

The cross sectional area and residence time for the second stage 20 are larger and longer compared to the first stage 10. These vessel conditions combined with a higher operating temperature ensure combustion of the carbon containing solids formed during pyrolysis within the first stage 10. Oxygen or air can be introduced through line 180, representing one or more conduits either continuously or in a pulse. Additional fuel may be added via line 300 as necessary to maintain the heat balance across the entire process, the amount of which will be controlled by the nature of the feed source.

The effluent gas from the second stage 20 will contain some solids which can be removed through one or more cyclones denoted 240. The solids are returned to the fluid bed through solids return line 250. Excess inert solids can also be removed through line 320 or from any other suitable location. There will be a significant amount of solids in effluent gas 260; however, through the proper balancing of flow conditions and cyclones, the amount of solids can be controlled as to not impact downstream operations. Specifically, solids produced in the second stage 20 are removed via cyclone 270 into line 330. The effluent 280 can be passed directly into heat exchangers to cool the gas prior to subsequent processing.

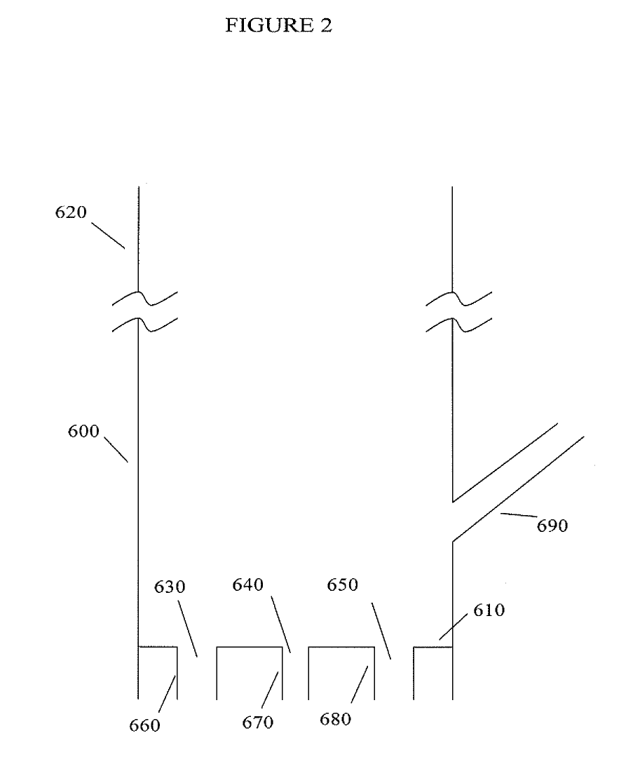

Referring to FIG. 2 hereof, for any stage within the gasifier system, this represents the section in which fluidizing gas is introduced showing a pressure containing boundary 600 which originates at the plane in which gas is introduced 610 to the upper portions of the fluidized bed 620. In this drawing, the nozzles 630, 640, and 650 which introduce a fluidization gas represent a subset of the plurality of nozzles required for the system. For simplicity, they are shown to be on a single plane but variations in height above the bottom 610 of the gasifier stage can also be utilized. The conduit required for transferring the fluidization gas from the source to the gasifier stage 600 are denoted as 660, 670, and 680. There can be a single conduit for each nozzle or multiple nozzles can be connected in one or more fluidizing gas conduits. The conduit for the introducing solids into the gasifier stage is shown as 690. This can be one or more conduits and is not significant with respect to this invention. The conduit conveys solids into the gasifier which can encompass feed for gasification or partially reacted feed containing char, carbon and/or soot that will undergo either additional gasification, partial oxidation or complete oxidation, depending upon the nature of the gasifier stage. In the majority of applications, inert solids used to promote fluidization and heat transfer will also be conveyed through conduit represented by 690.

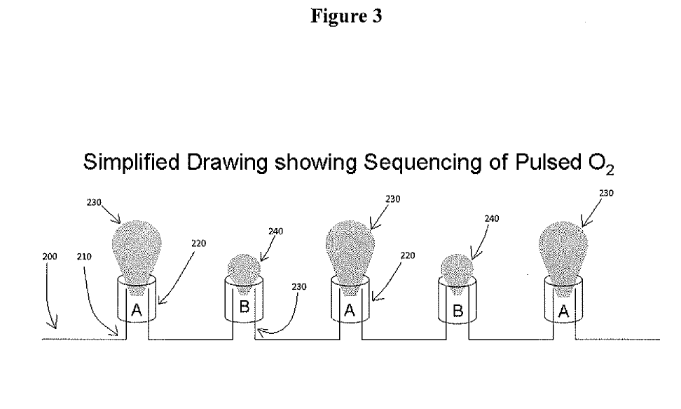

FIG. 3 hereof presents a simplified drawing of the pulsed O₂ sequence. In this example the nozzles conveying the fluidizing gas are shown on a single plane 200. Each nozzle 210 consists of the appropriate diameter or geometry to convey the appropriate amount of fluidizing gas over the cross section of the gasifier stage. A shroud 220 can be part of the nozzle geometry in order to facilitate the entrainment of the bulk fluidized gas and solids into the volume of the jet or bubble associated with the fluidization gas 230 and 240. When periodically introducing oxygen into the fluidization gas, there will be a local increase in temperature within the gas volume associated with the jet. This jet can also be considered a bubble forming at the exit of the nozzle and extending into the fluidized bed. As the O₂ flow is cycled from zero flow to some maximum and then decreased back to zero, the jet including the O₂ increases from zero to some maximum and then back to zero. The case of zero O₂ flow is not shown in FIG. 3. Within this jet volume a local temperature rise will occur due the relatively high oxidation rate compared to gasification. The temperature rise will dependent upon the volume of the O₂ introduced during the pulsed O₂ time period.

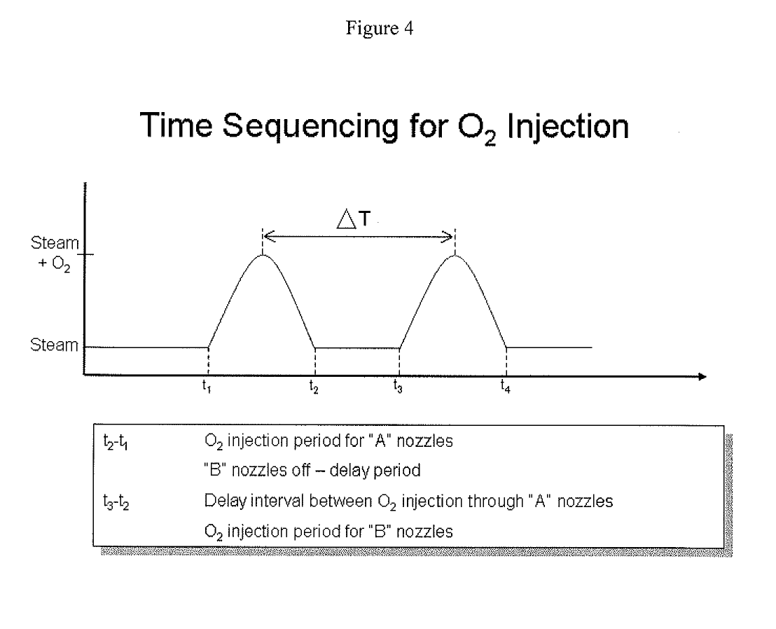

FIG. 4 hereof presents qualitative plot of the O₂ injection rate. The amount of O₂ introduced during each pulse cycle will establish the maximum temperature rise within the jet. The volume of O₂ introduced in each pulse is established by integrating the flow rate over the characteristic time period (t₂-t₁) and the interval between pulses is designated by (t₃-t₂). FIG. 4 refers to two classes of nozzles with “A” and “B” designations. This is a simple example in which adjacent nozzles (A and B) alternate pulsing in order to avoid a local high concentration of O₂ which can lead to a high local temperature.

The application of the present invention involves estimating the local temperature rise of the jet during the time period in which oxygen is introduced. Before determining the O₂ pulsation frequency and flow rate one must first establish the nozzle design required to achieve acceptable fluidization. This is relatively straight forward to one skilled in the art and involves establishing the fluidization properties for the feed, reaction intermediates, and inert solids in the bed. Once established, a heat balance over the various stages of the gasifier is required to determine how much oxygen needs to be introduced in the gasifier stages. This is again straight forward to one skilled in the art of fluidized beds. The amount of oxygen to be introduced into each stage can then be distributed over the nozzle geometry established for fluidization. One then determines if this oxygen requirement can be introduced over one or more subsets of nozzles for each stage, recognizing that the jet, or bubble, detachment from fundamental principals follows the relationship;

1/t_{detach} proportional to (g/Q)^{1/5}

where t_{detach} is the time frame in which gas from the gas entering the nozzle detaches and enters the fluidized bed, g is the gravitational constant, and Q is the flow rate. The detachment frequency is relatively insensitive to the total flow Q and in the application of this invention the total flow rate through each nozzle is not a significant consideration. The pulsing frequency (t₃-t₂) for O₂ must be less then this characteristic frequency which can be determined empirically or through direct measurement.

The temperature rise within the jet is dependent upon the flow rate of O₂ and the rate of local entrainment within each nozzle. Entrainment rates for specific nozzles must be empirically established since it is highly dependent upon the local geometry and local solids concentration. Empirical correlations exist allow one to estimate solids flux into a jet and from these estimates a local temperature rise within the jet can be established from the amount of oxygen which must be introduced into each nozzle. The invention requires that the local temperature rise based on the estimated entrainment of the bulk fluidization material (element 230 in FIG. 3 hereof) should not exceed the desired maximum operating temperature (in the range of about 1800° F. to 2000° F.). If this is the case, then the nozzle geometry for the fluidizing gas must be modified to allow less oxygen per nozzle. This modification can involve the use of smaller nozzle diameters, solids distribution system in the feed conduit(s) (690 in FIG. 2 hereof) or the use of entrainment devices (such as shrouds) to facilitate entrainment.

Once the local temperature rise for the appropriate amount of O₂ to be added to each gasifier section is found to be acceptable, the required pulse frequency can be established for a specific gasifier section. In the case where local temperature are excessive in a specific gasifier section, it may be possible to find other portions of the gasifier system where O₂ can be introduced without exceeding the maximum allowable temperature.

Returning again to FIG. 4 which presents a simplified drawing of the use of pulsed O₂. At the onset of the pulse, the pox zone is relatively small with only a modest increase in temperature. As time elapses, the incoming oxygen allows the pox zone to fully develop leading to a larger volume and higher temperatures within the zone. During this period of development, the temperature within the pox zone is increasing due to a combination of increasing oxygen flow and a decrease in the surface area to volume ratio. The duration of the pulse must be less than the time required to fully develop the pox zone. This time is approximated by the velocity of the incoming oxygen jet over the length of the penetration of the jet. The velocity is determined by the flow rate and the O₂ nozzle diameter while the jet penetration is established using existing correlations available in the literature and/or detailed momentum modeling (using computational fluid dynamics). The temperature within the pox zone during the pulsing period is determined through use of a heat balance relating the energy being released through pox and the cooling occurring due to the flux of cooler solids and gases passing through the pox zone. The heat balance can be solved within the boundaries defined by the extent of mass flux and the amount of endothermic reactions occurring within the pox zone. Using these boundaries, one can establish a temperature rise which is below the fusion and/or vapor pressure limit of the inorganic constituents within the biomass feed.

What is claimed is:

1. A two-stage process unit for converting a biomass feedstock to a syngas gas, which process comprises:
a) introducing an effective amount of steam into a gasifier stage containing a bed of fluidized solids;
b) introducing a fluidizing gas through a first plurality of nozzles located at the bottom of said first stage containing said bed of solids, thereby resulting in and maintaining the fluidized bed of solids;
c) operating said first stage at a temperature of about 1000° F. to about 1600° F.;
d) introducing a biomass feedstock having an organic fraction and an inorganic fraction, in particulate form, into said first stage containing a fluidized bed of solids wherein the residence time of said biomass in said first gasification reactor is an effective residence time that will result in conversion of at least about 90% of the organic fraction to gaseous products, thereby resulting in a syngas product stream and a carbon-rich particulate product;
e) pulsing oxygen through a plurality of nozzles into said first stage, wherein said pulsing is preformed to maintain the temperature of said first stage in the range from about 1000° F. but not greater than about 1600° F., and to keep the partial oxidation zone of said nozzles below the fusion temperature of the inorganic fraction of said biomass, wherein said plurality of nozzles are divided into one or more sets with each set of nozzles pulsing oxygen at the same or at a different frequency of time;
f) passing at least a fraction of said syngas phase product stream to a solids/gas separation zone wherein substantially all of any solids carried in said syngas product stream are removed, thereby resulting in a substantially solids-free syngas product stream;
g) passing said substantially solids-free syngas product stream to downstream processing;
h) transporting said carbon-rich particulate product from said gasification stage to a combustor stage;
i) introducing, through a second plurality of nozzles, an effective amount of a fluidizing gas into said second stage, thereby resulting in a second fluidized bed of biomass particulates and fluidizing solids;
j) operating said second stage in the temperature at least about 50° F. greater than that of said first stage, but not in excess of about 2000° F. and at a residence time from about 1 to 3 times that of said first gasification reactor;
k) returning at least a portion of the solids of second stage to said first stage; and
l) removing any excess solids from the process unit to maintain a predetermined balance of solids.

2. The process of claim 1 wherein the average particle size of the biomass feedstock is from about 1 micron to about 3 inches.

3. The process of claim 2 wherein the average particle size of the biomass feedstock is from about 150 microns to about 1.5 inches.

4. The process of claim 1 wherein the biomass feedstock is pretreated by subjecting it to a torrefaction process at temperatures from about 390° F. to about 665° F. to reduce the average particle size of the biomass feedstock from about 1 micron to about 300 mircons.

5. The process of claim 4 wherein the average particle size of the biomass feedstock is reduced to about 150 microns to about 300 microns.

6. The process of claim 1 wherein the biomass feedstock is a lignocellulose comprised of at least about 30 wt. % cellulose, hemicelluloses, or both.

7. The process of claim 6 wherein the biomass feedstock is comprised of at least about 50 wt. % cellulose, hemicellulose, or both.

8. The process of claim 1 wherein the fluidizing gas is selected from the group consisting of steam, CO₂, syngas product, product water, or a mixture thereof.

9. The process of claim 8 wherein the fluidizing gas is steam.

10. The process of claim 1 wherein the fluidizing solids are an alpha alumina.

11. The process of claim 10 wherein the fluidizing solids are an alpha alumina doped with Ca or K.

12. The process of claim 1 wherein at least a portion of the biomass feedstock is introduced into the gasification zone via a riser.

13. The process of claim 1 wherein the solids residence time of the gasification stage is a time effective for converting at least about 90 wt. % of the carbon present in the biomass.

14. The process of claim 13 wherein the solids residence time of the gasification stage is a time effective for converting at least about 95 wt. % of the carbon present in the biomass.

15. The process of claim 13 wherein the solids residence time of the gasification stage is a time effective for converting at least about 95 wt. % of the carbon present in the biomass.
